(19) United States
(12) Patent Application Publication
(10) Pub. No.: US 2011/0238496 A1
(43) Pub. Date: Sep. 29, 2011

(54) Systems and Methods for Generating Data from Mobile Applications and Dynamically Delivering Advertising Based on Generated Data

(76) Inventors: Vishal Gurbuxani, Santa Clara, CA (US); Jonathan Wen-Jay Liang, Saratoga, CA (US); Allen Gilliland, San Jose, CA (US); Sunil Verma, Fremont, CA (US); Sumit Rai, West Hills, CA (US); Krishna Subramanian, Fremont, CA (US)

(21) Appl. No.: 13/032,597

(22) Filed: Feb. 22, 2011

Related U.S. Application Data
(60) Provisional application No. 61/307,323, filed on Feb. 23, 2010.

(51) Int. Cl. G06Q 30/00; G06F 15/16

(52) U.S. Cl. 705/14.49; 709/217

(57) ABSTRACT

The present invention provides a platform for mobile application developers to optimize their applications based on usage data and user feedback. It also allows advertisement providers to deliver targeted advertisements through applications, on the basis of application usage data. The platform further allows application developers to obtain advertisements that provide the best revenue and are optimized for the application type and bandwidth.

### CROSS-REFERENCE TO RELATED APPLICATIONS

The present specification relies on U.S. Provisional Patent Application No. 61/307,323, filed on Feb. 23, 2010, for priority and is hereby incorporated by reference in its entirety.

### FIELD OF THE INVENTION

The present invention relates to a mobile application development and advertisement platform. More particularly, the present invention relates to developing applications for mobile hand held devices, obtaining user feedback and analytics in real time, and monetizing the application through advertising placement.

### BACKGROUND OF THE INVENTION

The development of software applications such as gaming applications especially designed for mobile devices such as mobile phones has increased greatly in the recent past. Apple™ owns, or is responsible for, approximately 80,000 applications in around 80 countries, and about 2 billion in downloaded applications. Usually, a mobile application developer programs an application for the mobile phone platform, such as an Apple™ iPhone™, and notifies the mobile phone company of an intention to launch. In most cases the mobile phone company, whether manufacturer or mobile network service provider, has a predefined procedure in place for authorizing an application to launch and be made available to its user network. Such procedures generally comprise conducting, and passing, one or more checks for quality, speed, among other variables.

Only after the developed application is submitted to the validation procedure and demonstrably conforms to predefined standards is it permitted to access, and operate on, a service provider's mobile phone platform. Hence, launching an application on a mobile phone platform requires the application to go through a time consuming process to obtain the mobile phone company's approval, often taking months before an already developed application can be approved for launch. This is in direct contrast to applications (e.g. web based gaming applications) designed to operate on conventional personal computers and obtained via the Internet in which a web based application developer can make updates, upgrades and/or revisions to applications available on-line and can make such improved versions of the application immediately available, without having to wait for the completion of a rigorous approval process.

Once an application is launched using a mobile phone company's launching platform, it is downloaded by users onto their mobile hand sets. After the application is launched, developers' access to program-related data is mediated and controlled by the mobile phone company, who generally does not gather critical program data. Accordingly, developers are typically only able to obtain a limited amount of information from the mobile phone company, such as the number of times the application is downloaded. Developers are typically unable to obtain any specific information regarding the performance and usage of the application and typically do not have information regarding the application users' demographics, the time of download, number of repeat users, among other variables.

Also, the developers are typically unable to obtain users' feedback regarding any bugs in the application, or comments that could lead to improved user experience, in real time, i.e. as the mobile game is being used or immediately upon occurrence of the bug. Hence, there is a need for systems and methods to enable mobile application developers to obtain device related information, such as the operating systems running on the mobile devices on which the application is being run, the wireless medium (e.g. 3g, Wi-ft, etc.) being used by the users of the application, the manner in which the users' interact with the mobile device and the speed and type of the users' mobile connection, among other variables.

Additionally, there is a need for systems and methods to enable mobile application developers to obtain application related information, such as the interaction flow of an application before it crashed, the most frequently used components of the application, and the latency of specific components in the application. There is also a need to enable mobile application developers to obtain user related and social information, such as the amount of time a user spends on the application, the location of the user when interacting with the application, users' opinion about different aspects of the application, the applications shared by the users, and the type of applications appreciated by the users.

Many applications developed for the mobile phone platform are available for free download. The number of applications that generate revenue by charging for each download is very low as compared to the freely available applications. According to statistics, 75% of Apple's downloaded 2 billion applications were free applications. The developers of freely downloaded applications generate revenue through advertisements which are displayed at any time during the application's run. A number of advertisement provider networks are available and a mobile application developer can sign up for these advertisement networks, redevelop the advertisement provider's program code to integrate with the application and then display or sell advertisements. However, if the developer integrates more than one advertisement provider's code with the application the application may become unstable and the chances of malfunction/crash increase manifold.

Further, in order to earn revenue through advertisement display a developer has to sign up for each individual advertisement provider network and integrate their code with the application, which may be cumbersome and time consuming. Also, since most of the advertisement provider networks are actually competitors, the task of integrating their code is rendered even more difficult. Further the developer has to physically manage and monitor each of the advertisement networks for maximizing revenue and avoiding the competing interests of different advertisement provider networks. Additionally, the developer has no criteria for determining which advertisement the application should call for display on a mobile device at which instant, in order to maximize fill rate and effective CPM (eCPM or ECPM). Maximizing fill rate ensures that when the application is running, a maximum number of advertisements are displayed. Maximizing effective CPM ensures a maximum return every 1000 times a particular advertisement runs via the application. However, in the absence of any usage/application analytics information available in real time it is impossible for a developer to maximize returns given the absence of user-specific information and limited bandwidth of a mobile phone. Hence, there is a need for a system and method that would aggregate advertisement provider networks and use analytical data to power a smart engine that automatically selects the best advertisement network to run at any given time, thus relieving the developer of this function, enabling real-time ad selection and delivery, and optimizing ad delivery for mobile phones that lack sufficient bandwidth.

Further, there are no effective methods or systems that enable the advertisement providers to find a most suitable target mobile phone audience for their advertisements, as there are no statistics on application versus user profile available. Hence, methods and systems of aggregating advertisement provider network so that a developer can at one time sign up for multiple advertisement providers are required. Also required are methods and systems for maximizing a developer's revenue by maximizing the fill rate and effective CPM and for enabling advertisement providers better place advertisements into applications based upon the most suitable target audience.

### SUMMARY OF THE INVENTION

The aforementioned and other embodiments of the present shall be described in greater depth in the drawings and detailed description provided below.

In one embodiment, the present specification discloses a computer readable medium for storing a plurality of programmatic instructions which, when executed by a processor, perform the following functions: 1) transmit, from a server, a portion of said programmatic instructions to a user in response to said user's request to access said portion of said programmatic instructions, 2) communicate with at least one application developed by said user, wherein said communication occurs between the at least one application and the transmitted portion of said programmatic instructions and wherein the at least one application and portion of programmatic instructions are adapted to concurrently execute on a mobile device, and 3) based on said communication, collect data, wherein said data comprises at least one of device identification data, application identification data, application usage data, advertisement display data, advertisement response data, or feedback data and wherein at least a portion of said data is caused to be transmitted by the portion of programmatic instructions executing on the mobile device to the server or another server.

Optionally, the programmatic instructions are adapted to receive said data and use said data to identify, select, or transmit an advertisement to the mobile device. The programmatic instructions dynamically select said advertisement based on said data and transmit said advertisement to said mobile device for display during execution of said application. The advertisement is selected from a plurality of advertisements from more than one advertising network. The dynamic selection is based on matching attributes of the application to attributes of the advertisement wherein said attributes comprise at least one of audience profile, type of application, or cost of application. The dynamic selection is adapted to select the advertisement that would generate a highest amount of payment to said user. The dynamic selection is adapted to select the advertisement based on a number of times the advertisement has already been displayed during execution of said application and a maximum number of times the advertisement is permitted to be displayed during execution of said application.

Optionally, the data is transmitted to the server or another server in encrypted form using Extensive Markup Language. The data is only transmitted to the server or another server when a Wi-Fi connection is available to said mobile device. The data is only transmitted to the server or another server when a wireless connection is available to said mobile device and when the processor usage of the mobile device is below 30%. The data is scheduled to be transmitted to said server based upon contents of said data, wherein said data comprises at least one of mobile device type, network latency, connection type, or application type. The portion of programmatic instructions comprises a payload routine, wherein said payload routine determines an optimal amount of data for transmission. The portion of programmatic instructions comprises a payload transmitter routine, wherein said payload transmitter routine transmits data to the server in response to a request from said user. The portion of programmatic instructions comprises a payload creator routine, wherein said payload creator routine removes non-dynamic information from data and causes only dynamically changing data to be sent to the server. The non-dynamic information includes at least one of a type of mobile device, model of the mobile device, device identifier of the mobile device, or connection type with the mobile device.

Optionally, the application usage data comprises at least one of level, class, event, description, location of the mobile device, date of use, time of use, amount of time the application is used, or demographics of a user of the application. The event data comprises at least one of when a user of the mobile device accesses data, when the user of the mobile device accesses a network, when the user of the mobile device touches the mobile device, or when the user of the mobile device activates an accelerometer in the mobile device. The portion of programmatic instructions comprises a common method, an application method, an events method, and a feedback method. The common method provides common data to the application method, events method, or feedback method, wherein said common data comprises at least one of mobile device location data, date data, time data, phone type data, network connection type, or session data. The events method monitors for an occurrence of predefined events in said application, wherein said predefined events comprise at least one of an instance of a mobile device user touching a screen of the mobile device, an instance of the mobile device user tapping the screen of the mobile device, an instance of the mobile device user tilting the screen of the mobile device, an instance of the mobile device user moving the screen of the mobile device horizontally, an instance of the mobile device user moving the screen of the mobile device vertically, or an instance of the mobile device user inputting data into the mobile device.

Optionally, at least one of the mobile device location, the mobile device network connection, or timestamp is associated with a monitored occurrence of a predefined event. The feedback method obtains an evaluation from a user of said application and wherein said evaluation comprises at least one of ratings, recommend to a friend, or comments. The feedback method generates an alert based on events logged by said application and wherein said alert is transmitted to said server and causes said server to transmit an alert email to said user.

In another embodiment, the present specification discloses a method for dynamically selecting and transmitting advertisements from a server to a mobile device for execution on the mobile device comprising: 1) registering an application developer, 2) receiving a request from the application developer to access a plurality of routines, 3) transmitting said plurality of routines to the application developer, wherein said routines are adapted to communicate with at least one application developed by the application developer and wherein the at least one application and transmitted routines are adapted to concurrently execute on a mobile device, 4) receiving data caused to be transmitted from the mobile device by said plurality of routines, wherein a portion of said data is collected by the routines communicating with the application during execution of the application and wherein said data comprises at least one of device identification data, application identification data, application usage data, advertisement display data, advertisement response data, or feedback data, and 5) using said data to identify, select, and transmit an advertisement to the mobile device for display during execution of said application, wherein said the advertisement is dynamically selected based on said data.

Optionally, the advertisement is selected from a plurality of advertisements from more than one advertising network. The selection is based on matching attributes of the application to attributes of the advertisement wherein said attributes comprise at least one of audience profile, type of application, or cost of application. The selection selects the advertisement that would generate a highest amount of payment to said application developer. The selection selects the advertisement based on a number of times the advertisement has already been displayed during execution of said application and a maximum number of times the advertisement is permitted to be displayed during execution of said application. The data is only transmitted to the server when a wireless connection is available to said mobile device and when the processor usage of the mobile device is below 30%. The routines comprise an events method and wherein said events method monitors for an occurrence of predefined events in said application, wherein said predefined events comprise at least one of an instance of a mobile device user touching a screen of the mobile device, an instance of the mobile device user tapping the screen of the mobile device, an instance of the mobile device user tilting the screen of the mobile device, an instance of the mobile device user moving the screen of the mobile device horizontally, an instance of the mobile device user moving the screen of the mobile device vertically, or an instance of the mobile device user inputting data into the mobile device.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 is a block diagram illustrating the mobile application development environment, in accordance with an embodiment of the present invention;

FIG. 2 illustrates an exemplary user interface presenting a summary of overall account statistics, in accordance with an embodiment of the present invention;

FIG. 3 illustrates a snapshot of another exemplary user interface showing a device user trend;

FIG. 4 illustrates various components of the application server according to one embodiment of the present invention;

FIG. 5 illustrates methods of the library module, in accordance with an embodiment of the present invention;

FIG. 6 illustrates an online form that may be filled by advertisement providers to select applications for targeted advertising, in accordance with an embodiment of the present invention;

FIG. 7 is a block diagram illustrating the process flow between the components of the segmentation module, in accordance with an embodiment of the present invention;

FIG. 8 illustrates an exemplary use scenario, in accordance with an embodiment of the present invention;

FIG. 9 is a pictorial representation of the functionality of the mobile application development platform of the present invention; and

FIG. 10 is a pictorial representation of the mobile application development platform of the present invention and its environment.

### DETAILED DESCRIPTION OF THE INVENTION

The present invention provides a mobile application development platform. The platform enables mobile application developers to obtain analytical information, such as user demographics, with respect to their applications, thereby enabling the developers to customize the application based on user experience. The platform also enables mobile application developers to maximize their revenues obtained from advertisement providers. In an embodiment, the present invention offers mobile application developers a programmatic library which can be used to develop their mobile application, monetize the application, and perform advanced analytics on application usage data.

The present invention is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In systems currently available for advertising via mobile devices, client side libraries are wrapped around advertisement network libraries, creating a large, inflexible programmatic library. Advertisement networks that do not have libraries integrated therein cannot participate in mobile advertising. Hence, currently available systems aim at client side technology optimization, which is inefficient and typically leads to application failure. This is because multiple advertisement provider's network libraries, if aggregated on the client side, increase application file size and force consumers to download large files wirelessly, thereby causing applications to crash and impairing application distribution.

The present invention provides a server side solution for advertising via mobile devices which enables the simple and rapid addition of new advertisement networks on the fly without requiring an application update and thereby enabling online advertisement networks to become instantly mobile. Server side integration reduces latency periods when making advertisement calls since the request for an advertisement does not go over the wireless network. Also, the server side architecture of the present invention enables extensibility to other platforms (for e.g. Windows Mobile, Blackberry, etc.) by creating a simple client module. Furthermore, the server side architecture of the present invention enables dynamic optimization of the advertising to the user's actual use of a client side application, thereby permitting more tailored advertising to be delivered to a client side application from a server in real-time.

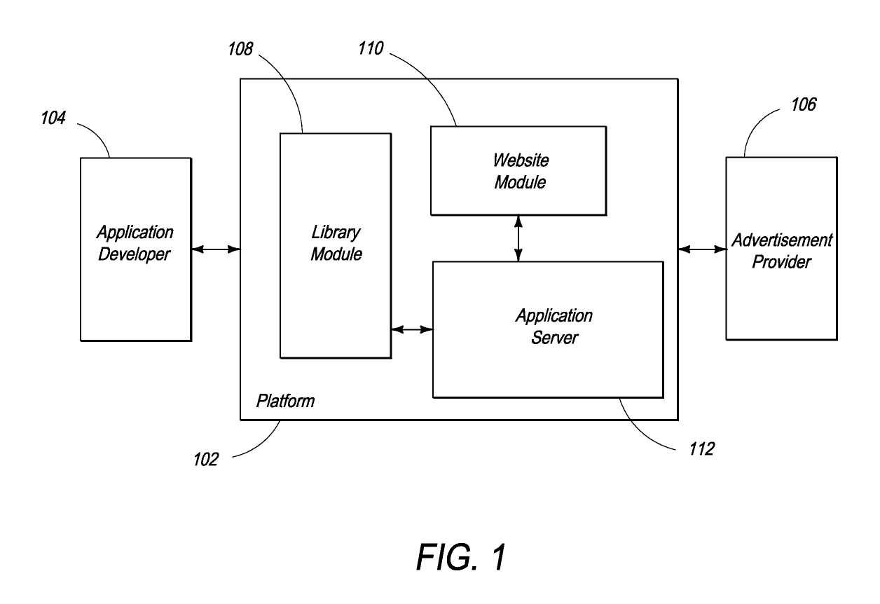

FIG. 1 is a block diagram illustrating the mobile application development environment, in accordance with an embodiment of the present invention. System, also referred to as a programmatic platform, platform, or software platform, 102 is configured to be accessible, via a network, to a plurality of computing devices, such as laptops, desktops, mobile phones, or other devices, operated by mobile application developers 104. Platform 102 is also configured to be accessible, via a network, to a plurality of computing devices, such as laptops, desktops, mobile phones, or other devices, operated by a plurality of advertisement provider networks 106. Platform 102 comprises at least a library module 108, a web site module 110 and an application server 112.

In operation, an application developer first accesses the library 108 of the platform, which comprises a plurality of programmatic modules including a software development kit (SDK) of the mobile phone platform corresponding to the mobile phone and/or network upon which the application is intended to run. To obtain access to the library 108, a developer first registers with, and logs into, to a website which is generated by website module 110 operating on a network accessible server and registers the mobile application metadata with the application server 112. The application server, executing on a network accessible server and accessible via the website module 110, prompts the developer for payment and contact details corresponding to a selected one of a plurality of available software development kits (SDK). In one embodiment, the payment and contact details, and other metadata for registration are obtained using a web-based user interface, as is known to persons of ordinary skill in the art. After registration the application developer is authorized to download an analytic library comprising the SDK. In various embodiments the platform 102 supports both manual and automatic sign up of application developers. Persons of ordinary skill in the art understand that the manual sign-up and automatic sign-up user interfaces obtain personal, business, and application details through conventional web-based forms and can be implemented through a standard website registration process.

An application developer then programs an application such as a gaming application for a particular mobile phone platform using the software development kit (SDK) of the mobile phone platform which is made available as part of the library module 108 of the mobile application development platform 102, as further described below.

Advertisement provider networks 106 provide advertisements which, when delivered to and displayed within an executing mobile phone application, generate revenue to the developer of the mobile application. In one embodiment, each advertisement provider network 106 is required to log in to the website 108 and provide predefined information such as payment and contact details in order to register with the mobile application development platform 102. In various embodiments the platform 102 supports both manual and automatic sign up of advertisement providers 106.

In one embodiment of the present invention, manual sign-up involves the developer importing their own advertising codes from their own relationship with certain advertising networks. In automatic sign-up, on the other hand, the application server 112 of the present invention uses custom components to sign-up relevant advertisement providers on the behalf of developers. This not only speeds up the registration process, but also allows the platform 102 of the present invention to be the central point of customer service and payments.

While the mobile application development platform 102 can be programmed using any programming language, in one embodiment, the Java programming language is used with support for any language that is supported by the advertisement provider networks 106 and the application developed by application developers. In one embodiment, the advertisement provider networks 106 support the Unicode (il8n) programming language. In another embodiment, developed applications pass a language parameter, which defines what language is used or implemented by the developed application, to the mobile application development platform 102. Each of the components of the mobile application development environment is further described below.

### Website Module

The website module 110 provides an interface for all Internet-based user interactions with the mobile application development platform of the present invention. One of ordinary skill in the art would appreciate that the website module comprises a plurality of program routines, stored on a memory medium such as a hard drive and installed on a computing platform, such as a server or other computing device, which is network accessible. The server comprises a plurality of processors which execute the plurality of program routines. The website module may or may not be stored, installed, or otherwise executed on the same server upon which the application server and/or library modules are stored, installed, or otherwise accessible.

In one embodiment, the website module, when executed, presents a website user interface which can be accessed by a wired or wireless network. A user, operating a computer, can access the website and, when presented with the appropriate user interface, can log into the website, register an advertising network or mobile application, and access advertising and/or mobile application trends, including the popularity of mobile applications, user ratings of mobile applications, and other statistics, as further described below.

In one embodiment, at least some of the plurality of program routines, when executed, present an information regarding the mobile application development platform; at least some of the plurality of program routines, when executed, present an application/user management section, and at least some of the plurality of program routines, when executed, present an analytics section. The analytics section further comprises a section displaying the trends for the applications using the platform of the present invention and a section displaying the trends for a plurality of mobile applications being used by a user in general.

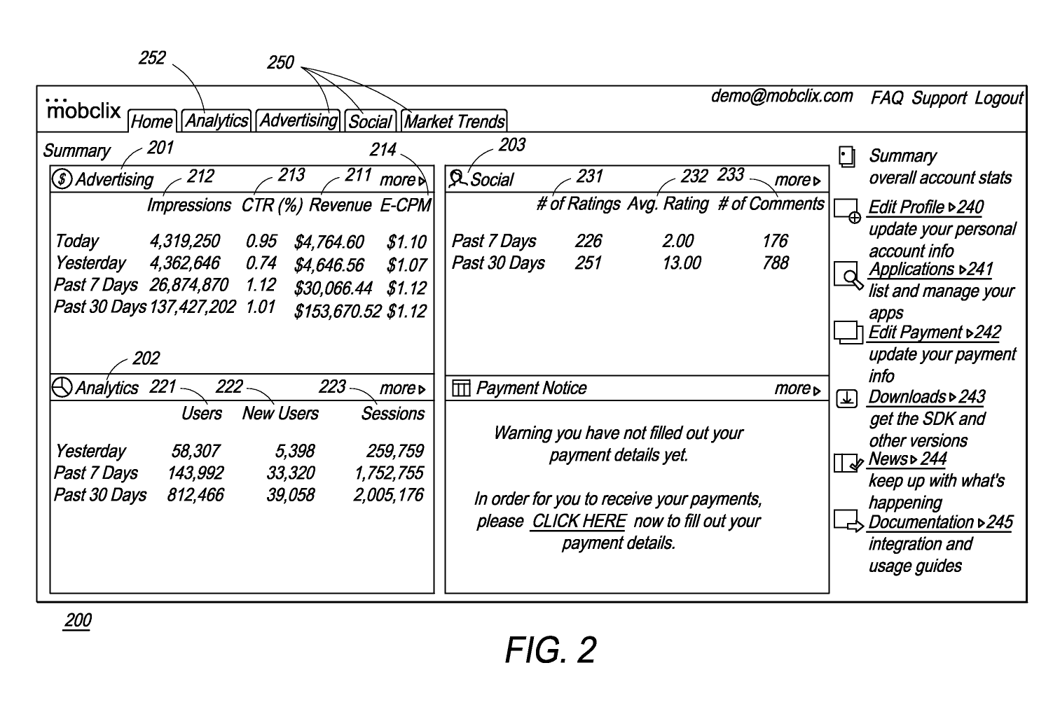

FIG. 2 illustrates an exemplary user interface 200 presenting a summary of overall account statistics. The user interface 200 presents statistics on advertising 201, such as advertising revenue 211, impressions, 212, click through rate (CTR) (in percentage) 213 and E-CPM 214. Further, this data may be available to the user for the current day, the day before, for the past week and for the past 30 days. The interface also includes a summary 202 of analytical data regarding usage of a given application, such as number of users 221, number of new users 222 and number of sessions 223. The data may be available for the current day, previous day, past one week and past one month. Further, the user interface 200 presents a summary of social statistics 203, which include number of ratings 231, average rating 232 and number of comments 233 for a particular application. This data may also be available for the current day as well as previous days.

Besides presenting a user with statistics, the user interface 200 also provides various links allowing a user to edit his or her profile 240, list and manage their applications 241, receive updates and make payments 242, download software development kits (SDK) 243, and access documentation 245 and news 244 related to their applications.

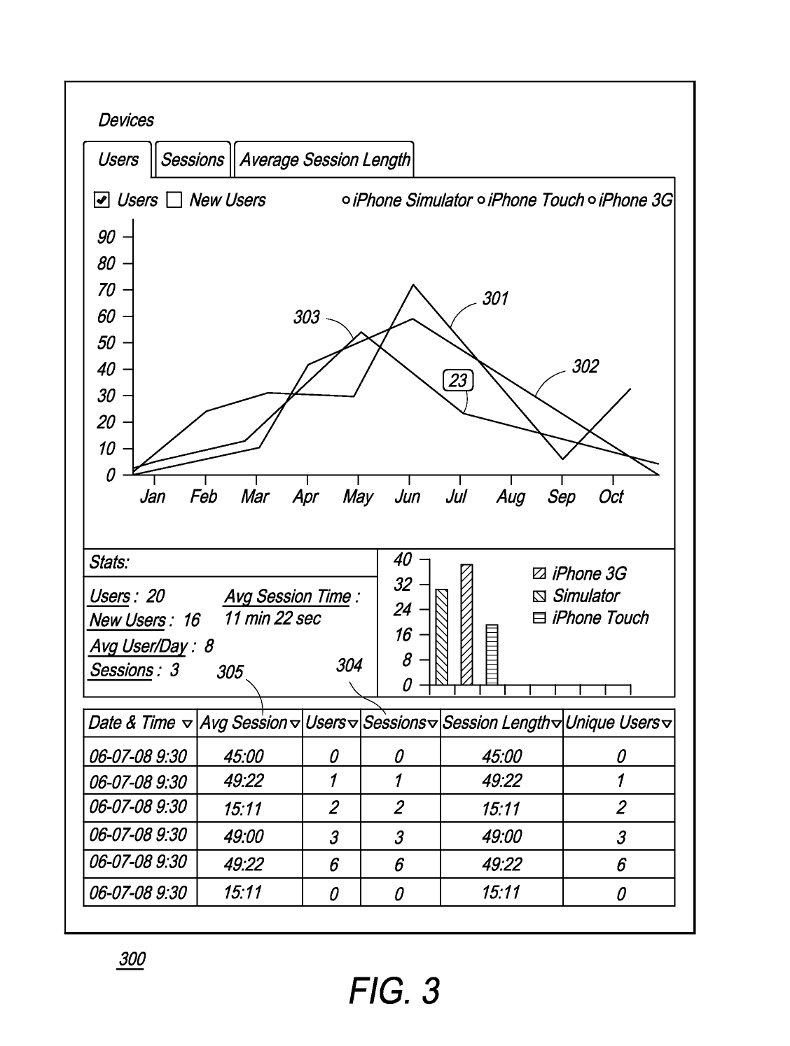

Apart from a summary of statistics, a user may also obtain detailed information from various tabs 250 in the user interface screen 200. For example, on clicking on tab 252, a user is presented with another user interface screen providing details of user trends for various types of devices. One such exemplary user interface screen is illustrated in FIG. 3. Referring to FIG. 3, the screen 300 illustrates user trends for three different models of mobile devices. Statistics shown in user interface screen 300 include, for example, the number of users using a given application over a period several months, illustrated by curves 301, 302 and 303 corresponding to three device types. Other statistics may include, for example, the number of sessions 304 and average session length 305 per application for each device type. One of ordinary skill in the art would appreciate that the above statistics are only exemplary, and the user interface may include any number of screens to present any kind of data related to a developer's applications and their usage on mobile devices.

In one embodiment, each of the aforementioned user interfaces are generated by a) passing the relevant variables to an analytics engine which is part of the application server, described below, b) receiving the processed results of the analytical engine, and c) formatting the received, processed results into the above-described results.

### Application Server

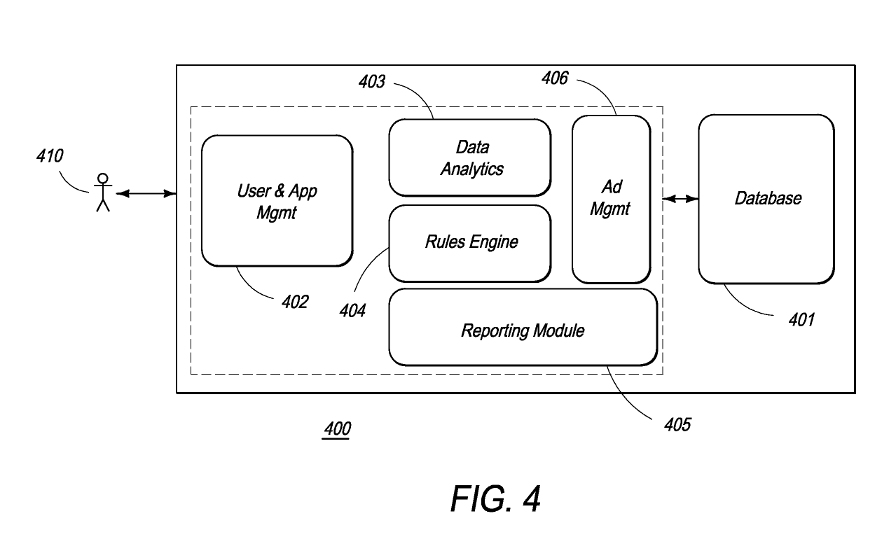

Various components of the application server (112 of FIG. 1) are illustrated in FIG. 4. Referring to FIG. 4, application server 400 comprises a database 401, user and application management module 402, data analytics 403 and rules engine 404, a reporting module 405 and an advertisement management module 406.

One of ordinary skill in the art would appreciate that the application server 400 comprises a plurality of program routines, stored on a memory medium such as a hard drive and installed on a computing platform, such as a server or other computing device, which is network accessible. Further, the application server 400 comprises a plurality of processors which execute the plurality of program routines. The application server may or may not be stored, installed, or otherwise executed on the same server upon which the website module and/or library modules are stored, installed, or otherwise accessible.

The database 401 stores all the data provided by the application developers and the advertisement providers as well as all the data received from applications running on mobile devices in real time. Therefore, database 401 dynamically interacts with all the other components of the application server.

One of ordinary skill in the art would appreciate that the database 401 may conform to any structure suitable for the application, such as but not limited to, flat files, ISAM, hash buckets, Hadoop, among other embodiments. In one embodiment, all the information is stored unstructured in the database. In one embodiment, the application server uses tailored Map Reduce functions for sorting through large amounts of information and providing analysis and analytics on the data.

The user and application management module 402 interfaces with users 410, including mobile application developers and advertisement providers, through website user interfaces to obtain registration data. Module 402 then uses and processes this data to manage user security, user group, user profile, user sign-up, ACL, and preferences. The application management module 402 also manages functions associated with applications registered by developers, such as application sign-up, application tracking, application meta-data, etc.

Data analytics 403 and rules engine 404 of the application server analyze the application data, such as user trends, advertising revenue, etc, and provide analytical results to website modules. The analyzed statistics are then presented via a web user interface. Data for analyses is obtained from mobile devices on which various applications, registered through the platform of present invention, are running Data analytics 403 and rules engine 404 receives and stores, in the database 401, usage data such as device type, operating system (OS) version, connection type, session time, demographic characteristics of user, location details, and behavioral characteristics of user. In one embodiment, users' behavioral characteristics are obtained from third party data sources, such as market research firms, as well as from custom behavioral segments obtained from a number of metrics related to user engagement within the application.

The data analytics 403 and rules engine 404 also receives and stores, in the database 401, application characteristics such as category, name, version, paid or free status, price point and file size. In one embodiment, data generated by feedback from users of various mobile-based applications is also recorded. This data includes, for example, ranking information of registered applications, ratings, user sentiments based on comments of users recorded on the website of the application, user sentiment on social networking sites and blogs, and trends from web based search engines.

The data analytics 403 and rules engine 404 are capable of performing comparative analyses to generate useful informative data, including application centric data obtained from feedback corresponding to each application, advertisement centric data, trend-centric data from usage data, and predictive data to predict application popularity.

In one embodiment, the data analytics and rules engine analyzes application based indicators to determine application popularity and influencers. These indicators include ranking of applications at online stores from where they can be downloaded, download numbers, rating, number of comments, and overall sentiment to the user. In one embodiment, data for these indicators is collected from national as well as international users. These indicators are then processed by the data analytics and rules engine in the application server to determine popular applications, as well as usage trends with respect to specific applications. Thus, for example, data analytics may be able to determine, from information gathered from usage of various mobile phone applications, which games are the most popular in touch-screen phones and which games are most popular when played using keypads.

In one embodiment, the platform of the present invention also gathers accelerometer data, GPS and location data, etc from mobile devices on which applications registered with the platform are being used, besides the application usage data. This allows the application server to generate specific analytical conclusions, such as for example, “X type of games are most popular for playing at airports”, “Ball games requiring tilt action are more popular”, and “Sudoku is solved more often by university students”, etc. One of ordinary skill in the art would appreciate that such analytics are not limited to game-based applications, but can be applied to data gathered for all kinds of applications running on mobile devices, such as:

Entertainment (movies, jokes, ring tones, etc),

Utilities (International time zones, Compass, etc),

Social Networking,

Music,

Productivity (To-do lists, Budget planner, etc),

Lifestyle (Grocery list, wine picker, etc),

Reference (Gardening, Cooking ingredients, etc),

Travel (Hotel searching, translator, etc)

Sports

Navigation (Maps, traffic information, etc)

Healthcare/Fitness (Weight guide, meditation, etc)

News

Photography (photo processing software applications)

Finance

Business (Tax calculator, Meeting notes, planner, etc)

Education (General Knowledge, math, dictionary, etc)

Weather

Books (e-Reader, etc)

Medical (Common ailments & OTC prescriptions etc).

One of ordinary skill in the art would further appreciate that the above list is not exhaustive, but only indicative of the several applications used on mobile devices, usage data for which can be gathered by the platform of present invention.

The analytical information obtained through the platform of present invention enable an application developer to make informed decisions regarding releasing newer versions of the application. Further, these results also enable advertising to be contextually delivered or generated based on the gathered data. For example, in one application which enables a user to search for and obtain a listing of movies, and then select a specific movie to book tickets using his/her mobile device, the platform of present invention captures GPS data and tracks the frequency by which the user searches from a specific geographic location. The most frequent geographic location is saved to the database 401, and the data analytics 403 and rules engine 404 associate it with an advertiser who has demonstrated a preference for advertising to that geographic location. In another example, the application server may capture data reflecting a user's preference in choice of theaters for booking tickets, and present the user with any promotions offered by their preferred theaters in future.

In one embodiment, the analytical engine comprises programmatic routines that uniquely index applications based on variables such as Session Length, Download Count, Engagement Level, User Retention, New User Growth, Intent of User, Location of where the application is played, and Amount of money spent within the application, besides category, ranking and popularity. In another embodiment, the analytical engine comprises programmatic routines to detect the speed at which mobile applications rise in ranking, popularity, and downloads. In yet another embodiment, the analytical engine comprises programmatic routines to detect user sentiment toward an application from third party data feeds including online stores from where applications can be downloaded, trends obtained from websites, blogs, social networking and media sites, and various other third party sites.

In one embodiment, the application server includes a sentiment monitor routine that is based on the ontology of an application category. The ontology of words is then weighted on a list that derives sentiment for a given users' opinion. The weight is then averaged against all the metrics that data analytics analyzes to give a score to the application.

In one embodiment, the analytical information obtained through the data analytics and rules engine is reported in real time to advertisement providers as well as application developers via the web site (110 of FIG. 1). The data analytics and rules engine also provides recommendations based on users, friends, recommendations, interests, segments, and behaviors to recommend relevant applications. In one embodiment, this kind of data is obtained from social media and networking sites, such as Twitter, Facebook, OpenSocia, Google Trends, etc, and from third party data sources, such as market research firms. Hence, the analytical functions provided by the analytical engine may also be categorized as social centric.

As shown in FIG. 4, the application server 400 further comprises a reporting module 405, which generates reports on the basis of analysis performed by the data analytics, and passes on the relevant reports to the users, viz. application developers and advertisement providers.

The application server 400 further comprises an advertisement management module 406 which is responsible for providing targeted advertising feature to advertisement provider networks. Targeted advertising is delivered on the basis of analytical information drawn from the data analytics and rules engine, as described above. The advertisement management module 406 is described in further detail in later sections of this specification.

### Library Module

Data from trends and variables described above is used by the application server to generate reports and to direct advertising for advertising networks. This data is generated and acquired by programmatic routines which are integrated into mobile applications by developers and which are part of the library module (108 of FIG. 1). One of ordinary skill in the art would appreciate that the library 108 comprises a plurality of program routines, stored on a memory medium such as a hard drive and installed on a computing platform, such as a server or other computing device, which is network accessible. The server comprises a plurality of processors which execute one or more of the plurality of program routines and/or makes such plurality of program routines available for downloading to registered application developers. The library may or may not be stored, installed, or otherwise executed on the same server upon which the website module and/or application server modules are stored, installed, or otherwise accessible.

In operation, the library routines, integrated into a mobile application, cause the application to post device and application identification codes, usage data as well as advertisement display/response data to the application server. In order to ensure that the user experience, in terms of speed or usability, is not affected during such transmission, data is transmitted whenever an Internet connection is present and CPU usage on the mobile device is not high. In one embodiment, the CPU usage is below 30%, 20%, 15%, 13%, 10%, 5% or any increment below 30% of usage time for an optimal configuration. The Library substantially constantly analyzes the user experience based on the session time of the components and frameworks in the application to predict the right time to send data and information.

In one embodiment, the library module 108 determines when to transmit data to the application server based upon an output by programmatic routine which uses the following variables: mobile device type, network latency, connection type, and application type. In one embodiment, the algorithm used by the library module to determine which data is to be transmitted to the application server, and when, is based on a mathematical model of an ‘ideal’ user experience. The variables mentioned above are analyzed and given a user experience index. If the index is at an acceptable threshold, the library sends the data to the server for collection.

In one embodiment, the library module also determines that the data payload is of the efficient size, and removes redundancy to transmit only the right amount of information. To address the size of payload and optimal transmission of data, the library module is equipped with the following subroutines:

Payload Watcher—This routine ensures that the library only sends data when an optimal size of the payload has been reached. This size is determined by factors such as the type of mobile device, hardware of the device, application type, and the network connection present.
Payload Transmitter—This routine enables the library module to only send data back to its servers when a developer manually forces the library to ‘sync’, or when the library programmatically sends the information. Attributes considered by the payload transmitter include CPU usage of the mobile device, network connection, and user intent.
PayLoad Creator—There are many attributes that come from a mobile device that the platform stores. Also, there is a subset of information that does not change and only needs to be sent once to the application server for processing. Examples of such attributes that do not change with each application or during a session include the type of mobile device, location, model, the Unique Device ID (UDID), and the connection type of the session. The PayLoad Creator routine ensures that only relevant/dynamic data is saved and sent back to the application server, and redundancy is avoided.

The library module 108 enables the mobile application developers to develop mobile applications for one or more mobile platforms by providing a software development kit (SDK). In an embodiment, the library module 108 provides the SDK for developing applications for the Apple iPhone, Blackberry, or Android platforms. In various embodiments, the library module 108 supports a plurality of code libraries such as XHTML (Direct Integration), Objective C (used with devices such as iPhone/iPod Touch), Java (used with Android/Blackberry based devices), Symbian, .NET, and WebKit. As discussed above, a mobile application developer downloads the library module uses the one or more programmatic routines in the library module to generate a mobile application.

Once successfully integrated into the code of the mobile application, one or more of the library modules causes the application to send application usage data, along with a developer identification code and an application identification code, in encrypted form to the application server 112 by using Extensive Markup Language (XML). In one embodiment, where the mobile application is adapted to execute on an Apple iPhone platform, the iPhone posts usage data to the application server 112 whenever an Internet connection is present and when CPU usage on iPhone is not high, e.g. in excess of 10%, 13%, 15%, 20%, 25%, or 30% or any increment below 30%, in order to ensure that performance is not adversely impacted.

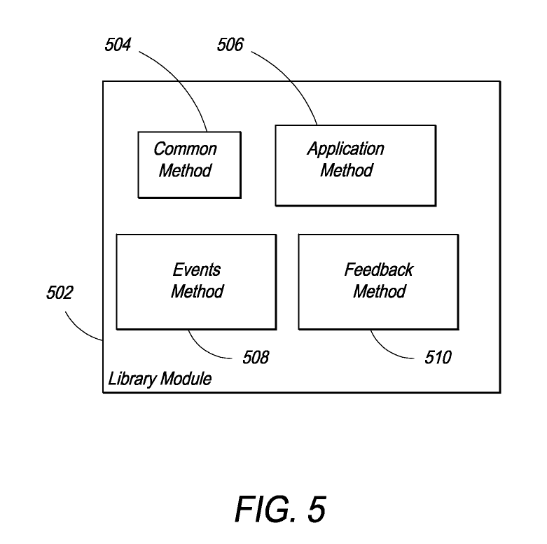

The library module 108 enables the developer to signal the start of application, signal the end of application, and log activities from parts of code in the application such as: the level, class name, event code (for example: data access, network access, touch/accelerometer), a description, the location of mobile handset on which the application is running, the date and/or time, the amount of time for which an application has been used, and identity of the components of the application that are being used. The library module 108 also enables obtaining feedback, comments and ratings from the users of the mobile application. In an embodiment, the library module 108 is implemented as a software program comprising one or more methods. The methods of the library module 108 are described in conjunction with FIG. 5.

FIG. 5 illustrates a plurality of methods of the library module, in accordance with an embodiment of the present invention. The library module 502 comprises a common method 504, an application method 506, an events method 508, and a feedback method 510. The common method calls 504 contain required information that application method 506, event method 508, and feedback method 510 calls include, and build from, to achieve their functionality. The common method 504 is responsible for inputting common data to the remaining methods. Examples of the common method 504 calls include: getLocation( ) which is used for obtaining the latitude and longitude of the place where the mobile application is running on a mobile device, getGMTdatetime( ) getIphoneType( ) which is used for obtaining the type of iPhone on which the mobile application is running, getCarrierName( ) for e.g. Wi-fi, getNetworkInfo( ) which is used for obtaining the IP address of the network connection being used by the mobile device, getSessionID( ) getCommon( ) which is used to obtain all the common data regarding a mobile application. In an exemplary embodiment, the following XML code is considered common data and the information between <appstats> is included in every method call:

<iphonestats
mobclix_library_version=‘0.01’
mobclix_xml_version=‘1’
application_id=‘A321Z3902900123123123’
developer_public_key=‘A12391023123123123123’
>
//getCommon
<appstats>
<common>
<latitude>37.331689</latitude>
<longitude>−122.030731</longitude>
//send these two fields out as a pair
<date_time>2008-06-24 11:08:44</date_time>
//give this in GMT date/time!
<iphone_type>?</iphone_type>
//describe the type of iphone user has, could be touch
<carrier_name>?</carrier_name>
//the name of the carrier, if it is wi-fi, then say ‘wi-fi’
<ip_addy>?</ip_addy>
//ip address
<session_id>?</session_id>
//users session-id
</common>
</appstats>
</iphonestats>

Application method 506 calls are methods relevant before the mobile application starts and after the mobile application ends. Examples of application method 506 calls comprise: startApplication( ) and stopApplication( ). In an exemplary embodiment, the following XML code is considered application data and the information in <appstats> is created for every method call:

<iphonestats
mobclix_library_version=‘0.01’
mobclix_xml_version=‘1’
application_id=‘A321Z3902900123123123’
developer_public_key=‘A12391023123123123123’
>
//startApplication
<appstats>
<common>
//all of the common data from common component
</common>
<analyze>
<stat_type>1</stat_type>
//the name of the statistic type
//ie: 1 = start_Time
<start_time>1214305725</start_time>
//the start time in GMT date/time format
</analyze>
</appstats>
//stopApplication
<appstats>
<common>
//all of the common data from common component
</common>
<analyze>
<stat_type>2</stat_type>
//the name of the statistic type
//ie: 2 = stop_Time
<stop_time>1214305758</stop_time>
//the start time in GMT date/time format
</analyze>
</appstats>
</iphonestats>

The events method 508 comprises developer customized events to monitor specific parts of a mobile application during execution. The events method provides flexibility to the developer to detail out their business process flow. The structure of an event, according to one embodiment, is as follows:

1. Business Process
a. Event 1
   i. Event 2 recursive
b. Event X recursive
   Preferably, every business process has the device information as well as location, network connection, timestamp associated with each event. As an example of use of events method, in a game application where a user is required to touch or tap on the screen to fire missiles to hit targets, the developer may choose to have the touch events stored, so that the action of missile firings may be optimized for users. Similarly, in an application where a user is required to tilt the screen to register an action, the developer may choose to have the tilt events stored. Similarly, in an application where a user is required to move screen objects horizontally to register an action, the developer may choose to have the horizontal movement events stored. Similarly, in an application where a user is required to move screen objects vertically to register an action, the developer may choose to have the vertically movement events stored. Similarly, in an application where a user is required to input text data to register an action, the developer may choose to have the text input events stored.

The feedback method calls 510 comprise methods which allow the mobile application developer to get instant feedback on specific parts of a mobile application from a user. The feedback method 510 focuses on functionality to enable mobile application developers to gain quick user rating and comments for their applications. Examples of feedback method 510 calls include: createAppRainng( ) and createAppComments( ). This feedback component enables recording/logging activities such as level, class name, framework from which the method call is made, description and event code such as data access/network access, from different parts of code in the mobile application. In an exemplary embodiment, the following XML code is considered feedback data and the information in <appstats> is created for every method call:

<iphonestats
mobclix_library_version=‘0.01’
mobclix_xml_version=‘1’
application_id=‘A321Z3902900123123123’
developer_public_key=‘A12391023123123123123’
>
//startApplication
<appstats>
<common>
//all of the common data from common component
</common>
<analyze>
<stat_type>3</stat_type>
//the name of the statistic type
//ie: 3 = app_rating
<overall>1</overall>
//out of 5 stars, the bigger the better
<usability>4</usability
<performance>4</performance>
<recommend_app_to_friend>5</recommend_app_to_friend>
<value_of_app>4</value_of_app>
//the start time in GMT date/time format
</analyze>
</appstats>
//stopApplication
<appstats>
<common>
//all of the common data from common component
</common>
<analyze>
<stat_type>4</stat_type>
//the name of the statistic type
//ie: 4 = app_comments
<class_name></class_name>
<description></description>
<comments></comments>
//the start time in GMT date/time format
</analyze>
</appstats>
</iphonestats>

In one embodiment, the feedback method enables the developer to leverage the library module to obtain quick feedback on a specific section of a mobile application. The feedback method allows the developer to set a flag in an application which establishes the number of times a user may be asked to provide feedback, e.g. if the developer wants feedback only once, then a pop up dialogue box appears before the user only once at a predefined time when the mobile application is running and prompts the user to enter a user rating and comment; if the developer wants feedback enabled all the time, a ratings/comments dialogue box is displayed during every startup sequence of the application. In one embodiment, a pop up dialogue box may urge the user to rate his current experience in the following areas (for example by allotting a specific number of stars out of 5 stars): usability, appearance, fun quotient, value quotient, recommend to friend, performance, and an overall rating.

In one embodiment, the feedback method generates alerts. Alerts are user generated thresholds created to automatically notify the developer when the thresholds have been passed. For example, a developer can create a threshold/rule when an event has a log level of ‘high’. If the application server receives data from the mobile device with events of ‘high’ logged, alarm information is emailed to the developer. Hence, alerts are created to help the developer get notified of problems that occur on their mobile application, without having to login to the website as a first step.

### Advertisement

In various embodiments, the mobile application development platform of the present invention provides an opportunity for the mobile application developers to leverage advertisement providers in an efficient manner and maximize advertising revenue. Advertisement provider networks transmit advertisements which when displayed on a mobile device while an application is running on the device generate revenue to the developer of the mobile application. In the absence of the mobile application development platform, an application developer would have to manage advertisement provider networks individually which, as stated above, is an inefficient and cumbersome task. The present invention enables a developer to maximize fill rates, by making sure that when the mobile application is running on a mobile device, the maximum number of advertisements is displayed to a user automatically. The present invention also enables maximizing effective CPM (ECPM) which defines the amount of money earned every 1000 times an advertisement runs.

In various embodiments, when a mobile application developer registers an application on the mobile application development platform, the developer's application is automatically linked to a plurality of advertisement providers. In one embodiment, the present invention supports 300×50 and 300×250 advertisement display sizes for mobile applications. Rich media is available on all applications developed using the present invention. The advertisements displayed on mobile devices using the present invention are true interactive advertisement units that incorporate the accelerometer, sound, force, gesture, and touch of a web view.

The advertisement management module of the application server 112 aggregates advertisement provider networks to maximize returns for the developer. Fill rate and ECPM corresponding to each mobile application developed using the platform of the present invention are maximized via a rules-base algorithm executed by the advertisement management module, that selects the best advertisement network to run.

In one embodiment, the application developer is provided with an option of overriding automatic advertisement allocation and selecting which advertisement provider to run manually. Advertisement serving logic is based on a plurality of factors such as segmentation trend data, advertisement trend data, location application Trend Data. The mobile application development platform allows for the Manual Override for segmentation Trends (allowing manual creation of segmentations and eCPMs), advertisement trends (allowing manual customization of advertisement trend data), location (allowing manual Override of location based revenue). In one aspect, the platform of the present invention works by pooling information for all the advertisement networks associated with it and their running campaigns. The platform then stores the eCPM value for the ad network, campaign, region (to indicate location based revenue), for a given application and related user segments. Thereafter, the platform analyzes the trend data for all these parameters in real time to select the right ad network partner when an ad is to be served during an application run. The mobile application platform also allows for the manual override of trend data and manual ad network selection.

The advertisement management module of the application server continuously monitors advertisement provider networks over a predefined interval of time which is optimized for each network. A connection to an advertisement provider network may be performed by the mobile application development platform by using a plurality of methods such as: importing of advertisement network data which can be done via CSV, XML, or custom data format or can be manually ingested or emailed; direct application protocol interface (API) integration wherein the platform can connect via an API and request advertisement network performance based on a structured request; web scraping of data wherein the platform can login and web scrape the advertisement provider network's website for advertisement network information. Hence, the present invention enables mobile application developers to optimize revenue by selecting a highest paying advertisement in real time.

This optimization is achieved, at least in part, by analyzing eCPM and other trend data in real time to select the right ad network partner during an application run, as described above. For this purpose, ad networks are continuously monitored at intervals optimized for the particular ad network, and the mobile application platform leverages the ad network data to refresh its statistics on ad network performance.

In one embodiment, the authorization for selecting an optimum advertisement on the behalf of the developer is made based on a security certificate, and partnership (between an application developer and an ad network) is made when an ad network is registered with the mobile application platform.

In an embodiment, the advertisement management module shares a list of mobile application developers registered with the mobile development platform with registered advertisement provider networks, which are thereby able to provision which applications they would like to be connected to via the an advertisement management API. The advertisement management module allows developers to see the advertisements of advertisement campaigns that have run on their application(s). The developers can then flag advertisements that they do not want to be shown on their applications. Further the advertisement management module allows developers to create filter lists of advertising that they allow and disallow on their applications. In an embodiment, advertisements may be filtered on the basis of competing applications, categories, content, keywords, metadata, and location.

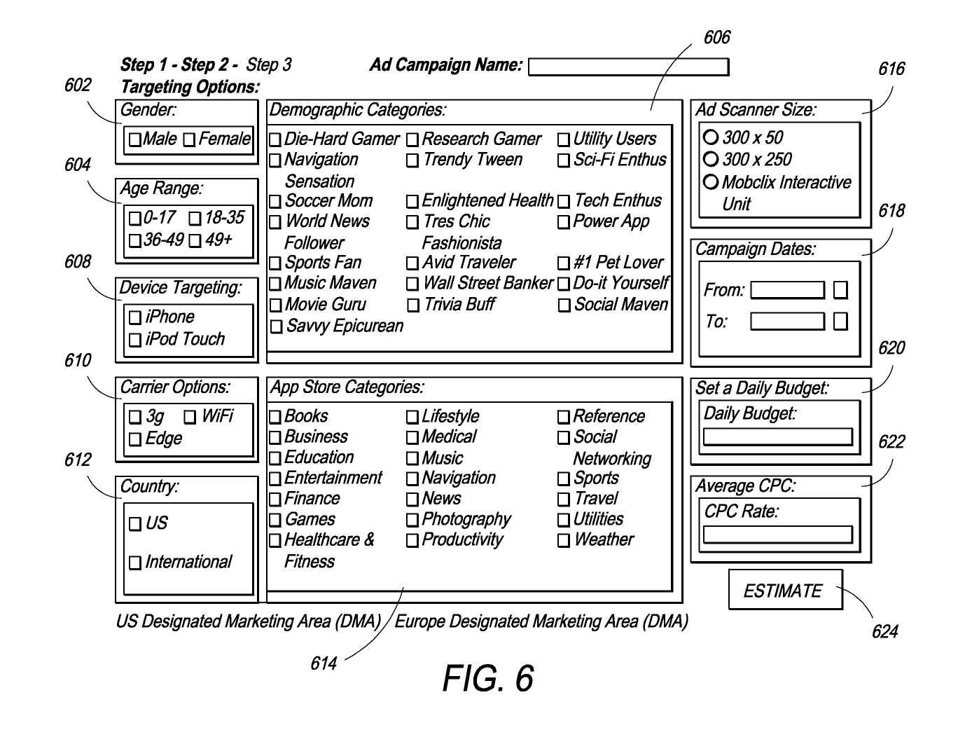

FIG. 6 illustrates an online form that may be filled by advertisement providers to select applications for targeted advertising, in accordance with an embodiment of the present invention. An advertisement provider may select gender, age range and demographic characteristics of a targeted application user in sections 602, 604 and 606 respectively. A targeted device (e.g. Apple iPhone or iTouch), wireless type (e.g. 3g, Wi-fi or Edge), and country may be selected in sections 608, 610 and 612 respectively. Section 614 displays application categories such as ‘books’, business', ‘education’, etc., one or more of which may be selected. A size of advertisement display, dates of targeted display, average daily budget and an average CPC rate may be entered in sections 616, 618, 620 and 622 respectively. Upon clicking button 624 an estimate for a targeted advertising campaign is generated for the advertisement provider who can then proceed to bid for the selected target applications. In an embodiment, the advertisement providers may also select an advertisement display option such as full screen interstitial display (pre or post application), floater display (mid application), fold over display or a personalized banner display.

In an embodiment, the advertisement management module can translate web based advertisements onto a mobile platform. This is achieved by using a workflow engine written in Javascript that translates the advertisement website into mobile capability. The present invention provides a dynamic workflow engine to convert flash based websites to mobile optimized formatting, which also supports a plurality of application based currency models. The workflow engine optimizes the delivery and registration of offers from 3rd party networks, and provides an extensible system for the auditing, tracking, and collection of currency based fulfillment models. Further, the workflow engine speeds up the conversion of online web based offers to mobile optimized sites.

In an embodiment, the present invention provides the advertisement providers with a method for targeted advertising. The advertisement management module of the application server (406 of FIG. 4) comprises a segmentation module which is responsible for providing targeted advertising feature to advertisement provider networks. The segmentation module provides a rule based algorithm which creates mobile application segments. These segments break up the types of applications into categories and the advertisement providers purchase these targeted segments to advertise into.

Examples of such application segment include women-oriented, students, teens, working executives, young mothers, etc. The advertisement providers may target applications based on geographical, vertical, behavioral or demographic characteristics of the application and its users. In one embodiment, ‘impressions’ are used as one of the criteria for segmentation. Impressions are defined when an ad is served on the application to the user, and include statistics such as eCPM, number of clicks, revenue, number of users, number of new users, number of applications, etc. The segmentation module leverages data obtained from application developers and their applications running on mobile devices to help enhance targeting by using user segments which are behavioral segments created by leveraging multiple input parameters from running applications; and advertisement network input parameters to target specific campaigns to increase the overall CPM and user relevancy. Behavioral segments are used to predict advertisement network pricing as well as advertisement network relevancy.

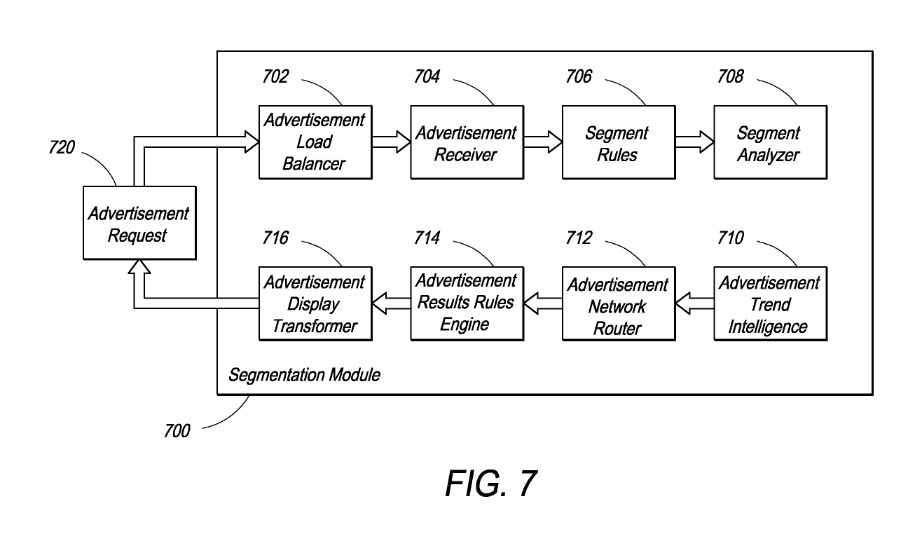

FIG. 7 is a block diagram illustrating the work flow amongst the components of the segmentation module, in accordance with an embodiment of the present invention. The segmentation module 700 comprises an Advertisement Load Balancer 702, an Advertisement Receiver 704, a Segment Rules module 706, a Segment Analyzer module 708, an Advertisement Trend Intelligence module 710, an Advertisement Network Router 712, an Advertisement Results Rules Engine 714, and an Advertisement Display Transformer 716. The work flow amongst various components of the segmentation module is aimed at filtering target applications and users on the basis of variables selected by the advertisement provider, such as the size of advertisement display, dates of targeted display, average daily budget and an average CPC rate, and directing the advertising towards the set of applications filtered on the basis of specified variables.

Accordingly, an ad request is first received by the Advertisement Load Balancer 702, which ensures that every request made by an application is handled and balanced in a timely fashion. Thereafter, the Advertisement Receiver 704 looks up available segments for advertisement providers. Application segments are described in accordance with pre-defined rules in the Segment Rules module 706. Thereafter, the Segment Analyzer 708 correlates all available segments for advertisement providers. The Advertisement Trend Intelligence module 710 looks up past performance based on segments and advertisement networks. On the basis of feedback from Advertisement Trend Intelligence module 710 and the availability of segments, the Advertisement Network Router 712 seeks the advertisements requests from all relevant advertisement provider networks, for all the available segments. These advertisement requests are then filtered by the Advertisement Results Rules Engine 714 to optimize ad selection for a given application and keeping in view the preferences of application developer. That is, user (application developer) data provided to the mobile application platform is matched by the Rules engine 714 against the advertisement requests, and combined with real time analysis of ad network performance data (through the Trend Intelligence module 710) to deliver ad content optimized of for a given application. Optimization of ad selection has been described in more detail in the ‘Advertisement’ section. The Advertisement Display Transformer 716 then prepares the ad data in a format appropriate to be delivered to specified mobile devices.

In one embodiment, the Advertisement Network Router 712 makes advertisement requests to an advertisement provider network. The Advertisement Result Rules Engine 714 awaits for the results and if the response is not returned in a predefined period of time, which in an embodiment is defined by the average response time on a per advertisement provider network basis, the Advertisement Result Rules Engine 714 automatically removes the advertisement provider network from competing for inventory. Hence, the present invention provides the advertisement providers with an opportunity to promote branding and awareness, generate leads and capture data within mobile applications.

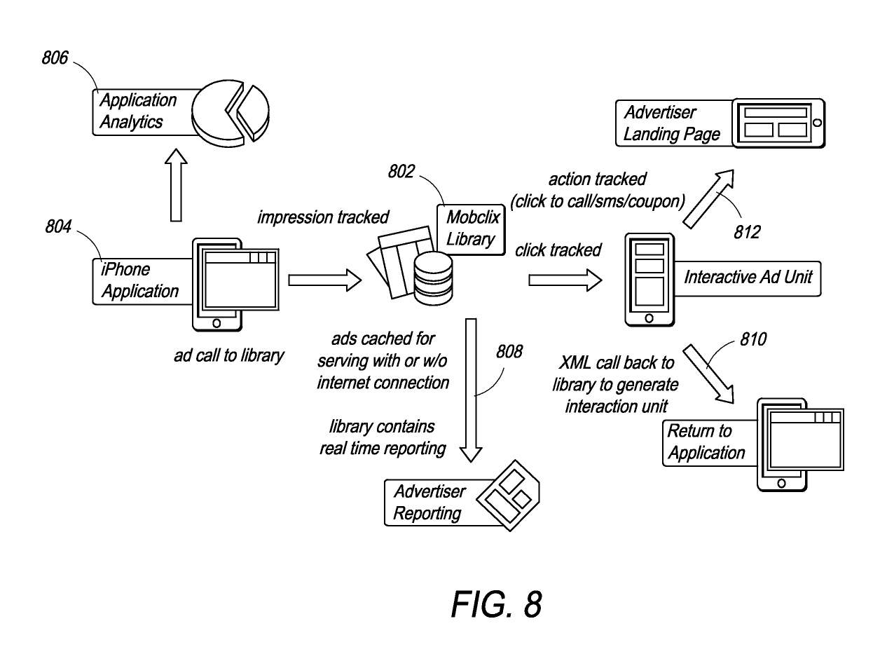

FIG. 8 illustrates an exemplary use scenario, in accordance with an embodiment of the present invention. In order to develop a mobile application using the platform of the present invention, a developer logs in to a website, registers the mobile application metadata, and downloads a plurality of library modules 802 comprising a SDK corresponding to specific mobile devices on which the application would run. The developer builds the application and adds an application identifier and user identifier as keys to the downloaded library. The application, while running on a mobile device 804, posts usage data such as device type, operating system (OS) version, connection type, session time, demographic characteristics of user, location details, behavioral characteristics of user, application characteristics such as category, name, version, paid or free status, price point and file size, to one or more application servers whenever Internet connection is present and CPU usage on the mobile device is not high. It should be appreciated that an application developer can establish data extraction and transmission rules that limit the collection or transmission of data based on end user privacy agreements or cost of data transmission from a mobile device to a server, thereby avoiding highly personal data from being sent and avoiding imposing excessive data transmission costs on the end user.

The application running on the mobile device also transmits information such as the number of advertisements viewed, the number of advertisements clicked on, the number and category of applications downloaded, eCPM per category, and eCPM per network and by ad size. For example, in case of an application running on an iPhone, data can be gathered from movement, i.e. the accelerometer, and answers to questions such as: how does a user use the device and how often does the user use the device can be obtained in order to correlate user actions to a specific category of applications.

The transmitted information is analyzed at 806 to obtain information such as application ranking, velocity, user feedback, comments and surveys. The obtained analytical information is reported in real time to advertisement providers at 808 via a web site. The library 802 contains advertisements cached for serving with or without Internet connection. When the application running on mobile device 804 makes an advertisement call, the cached advertisement is served to the mobile device 804. if the served application is clicked on by a user, either an XML call is made to the library 802 to generate an interaction unit at 810 or the user is directed to an advertiser landing page at 812.

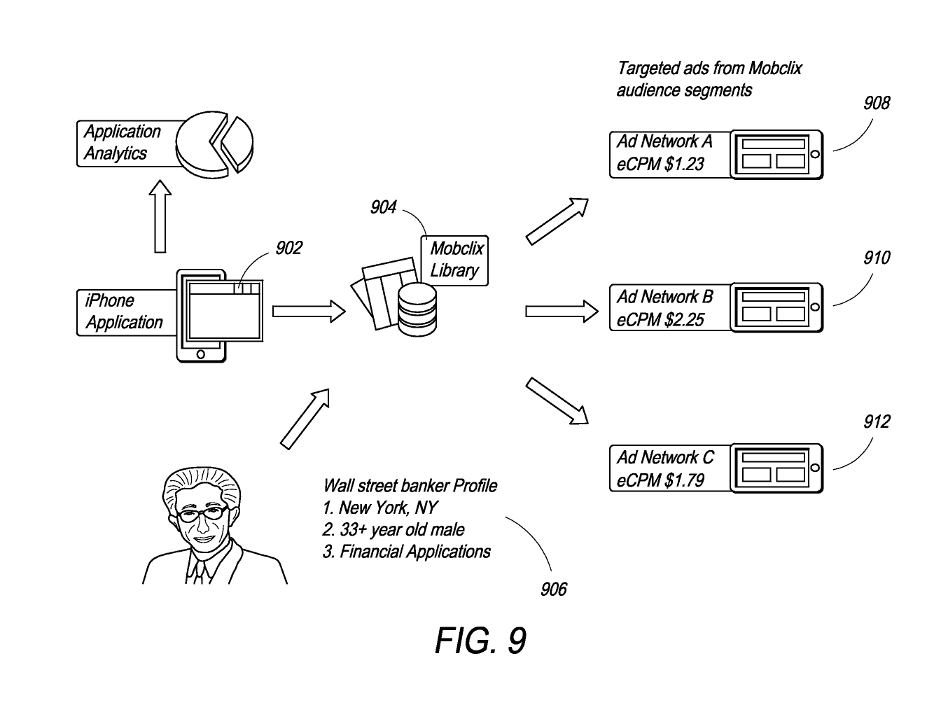

FIG. 9 is another pictorial representation of certain functionality of the mobile application development platform of the present invention. While running on a mobile device 904, a mobile application 902, developed using a plurality of library modules, posts usage data which includes behavioral characteristics of its user to one or more application servers via the library module 904 whenever Internet connection is present and CPU usage on the mobile device is not high. An analytical engine running on the application server uses the posted behavioral data to generate a user profile 906. An advertisement management module of the application server selects advertisement provider networks A, B and C 908, 910 and 912 using the aforementioned methods and the application user's profile. Advertisements from the advertisement providers A, B and C 908, 910 and 912 are displayed on the phone via application 902. Again, it should be appreciated that an application developer can establish data extraction and transmission rules that limit the collection or transmission of data based on end user privacy agreements or cost of data transmission from a mobile device to a server, thereby avoiding highly personal data from being sent and avoiding imposing excessive data transmission costs on the end user.

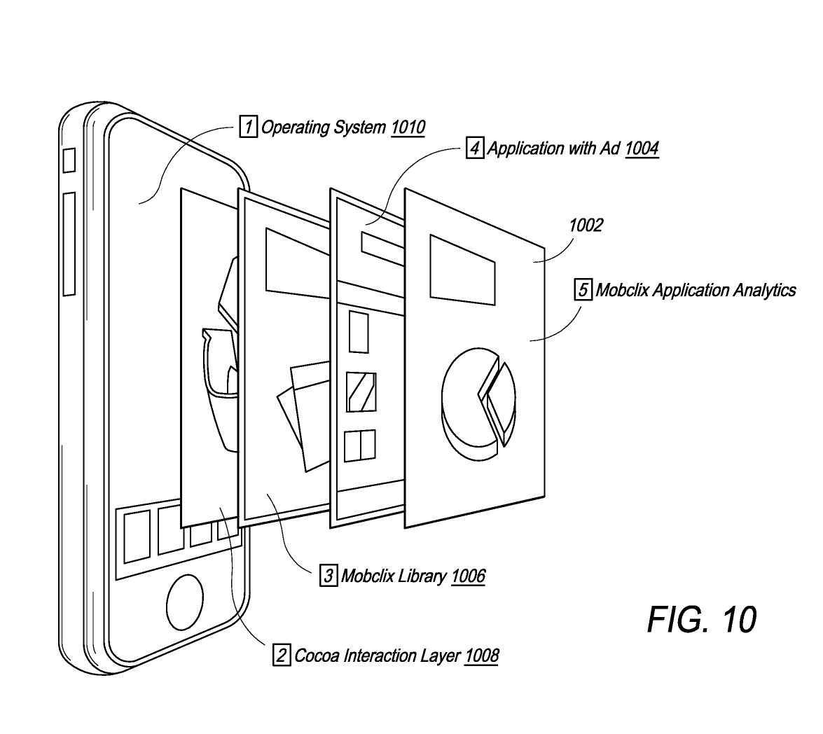

FIG. 10 is a pictorial representation of one embodiment of the mobile application development platform of the present invention and its environment. An analytical engine 1002 aggregates and analyzes usage data obtained from a mobile application 1004 running an advertisement. The application 1004 is built upon a library 1006 provided by the application development platform of the present invention. The library 1006 is integrated upon an interaction layer 1008 and an operating system 1010 of the mobile device 1012 (which in an exemplary embodiment is an Apple iPhone, as illustrated) on which the application 1004 is running

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A computer readable medium for storing a plurality of programmatic instructions which, when executed by a processor, perform the following functions:
a. Transmit, from a server, a portion of said programmatic instructions to a user in response to said user's request to access said portion of said programmatic instructions;
b. Communicate with at least one application developed by said user, wherein said communication occurs between the at least one application and the transmitted portion of said programmatic instructions and wherein the at least one application and portion of programmatic instructions are adapted to concurrently execute on a mobile device; and
c. Based on said communication, collect data, wherein said data comprises at least one of device identification data, application identification data, application usage data, advertisement display data, advertisement response data, or feedback data and wherein at least a portion of said data is caused to be transmitted by the portion of programmatic instructions executing on the mobile device to the server or another server.

2. The computer readable medium of claim 1 wherein the programmatic instructions are adapted to receive said data and use said data to identify, select, or transmit an advertisement to the mobile device.

3. The computer readable medium of claim 2 wherein said programmatic instructions dynamically select said advertisement based on said data and transmit said advertisement to said mobile device for display during execution of said application.

4. The computer readable medium of claim 3 wherein said advertisement is selected from a plurality of advertisements from more than one advertising network.

5. The computer readable medium of claim 3 wherein said dynamic selection is based on matching attributes of the application to attributes of the advertisement wherein said attributes comprise at least one of audience profile, type of application, or cost of application.

6. The computer readable medium of claim 3 wherein said dynamic selection is adapted to select the advertisement that would generate a highest amount of payment to said user.

7. The computer readable medium of claim 3 wherein said dynamic selection is adapted to select the advertisement based on a number of times the advertisement has already been displayed during execution of said application and a maximum number of times the advertisement is permitted to be displayed during execution of said application.

8. The computer readable medium of claim 1 wherein said data is transmitted to the server or another server in encrypted form using Extensive Markup Language.

9. The computer readable medium of claim 1 wherein said data is only transmitted to the server or another server when a Wi-Fi connection is available to said mobile device.

10. The computer readable medium of claim 1 wherein said data is only transmitted to the server or another server when a wireless connection is available to said mobile device and when the processor usage of the mobile device is below 30%.

11. The computer readable medium of claim 1 wherein said data is scheduled to be transmitted to said server based upon contents of said data, wherein said data comprises at least one of mobile device type, network latency, connection type, or application type.

12. The computer readable medium of claim 1 wherein said portion of programmatic instructions comprises a payload routine, wherein said payload routine determines an optimal amount of data for transmission.

13. The computer readable medium of claim 1 wherein said portion of programmatic instructions comprises a payload transmitter routine, wherein said payload transmitter routine transmits data to the server in response to a request from said user.

14. The computer readable medium of claim 1 wherein said portion of programmatic instructions comprises a payload creator routine, wherein said payload creator routine removes non-dynamic information from data and causes only dynamically changing data to be sent to the server.

15. The computer readable medium of claim 14 wherein said non-dynamic information includes at least one of a type of mobile device, model of the mobile device, device identifier of the mobile device, or connection type with the mobile device.

16. The computer readable medium of claim 1 wherein said application usage data comprises at least one of level, class, event, description, location of the mobile device, date of use, time of use, amount of time the application is used, or demographics of a user of the application.

17. The computer readable medium of claim 16 wherein the event data comprises at least one of when a user of the mobile device accesses data, when the user of the mobile device accesses a network, when the user of the mobile device touches the mobile device, or when the user of the mobile device activates an accelerometer in the mobile device.

18. The computer readable medium of claim 1 wherein said portion of programmatic instructions comprises a common method, an application method, an events method, and a feedback method.

19. The computer readable medium of claim 18 wherein said common method provides common data to the application method, events method, or feedback method, wherein said common data comprises at least one of mobile device location data, date data, time data, phone type data, network connection type, or session data.

20. The computer readable medium of claim 18 wherein said events method monitors for an occurrence of predefined events in said application, wherein said predefined events comprise at least one of an instance of a mobile device user touching a screen of the mobile device, an instance of the mobile device user tapping the screen of the mobile device, an instance of the mobile device user tilting the screen of the mobile device, an instance of the mobile device user moving the screen of the mobile device horizontally, an instance of the mobile device user moving the screen of the mobile device vertically, or an instance of the mobile device user inputting data into the mobile device.

21. The computer readable medium of claim 20 wherein at least one of the mobile device location, the mobile device network connection, or timestamp is associated with a monitored occurrence of a predefined event.

22. The computer readable medium of claim 18 wherein said feedback method obtains an evaluation from a user of said application and wherein said evaluation comprises at least one of ratings, recommend to a friend, or comments.

23. The computer readable medium of claim 18 wherein said feedback method generates an alert based on events logged by said application and wherein said alert is transmitted to said server and causes said server to transmit an alert email to said user.

24. A method for dynamically selecting and transmitting advertisements from a server to a mobile device for execution on the mobile device comprising:
a. Registering an application developer;
b. Receiving a request from the application developer to access a plurality of routines;
c. Transmitting said plurality of routines to the application developer, wherein said routines are adapted to communicate with at least one application developed by the application developer and wherein the at least one application and transmitted routines are adapted to concurrently execute on a mobile device;
d. Receiving data caused to be transmitted from the mobile device by said plurality of routines, wherein a portion of said data is collected by the routines communicating with the application during execution of the application and wherein said data comprises at least one of device identification data, application identification data, application usage data, advertisement display data, advertisement response data, or feedback data; and
e. Using said data to identify, select, and transmit an advertisement to the mobile device for display during execution of said application, wherein said the advertisement is dynamically selected based on said data.

25. The method of claim 24 wherein said advertisement is selected from a plurality of advertisements from more than one advertising network.

26. The method of claim 24 wherein said selection is based on matching attributes of the application to attributes of the advertisement wherein said attributes comprise at least one of audience profile, type of application, or cost of application.

27. The method of claim 24 wherein said selection selects the advertisement that would generate a highest amount of payment to said application developer.

28. The method of claim 24 wherein said selection selects the advertisement based on a number of times the advertisement has already been displayed during execution of said application and a maximum number of times the advertisement is permitted to be displayed during execution of said application.

29. The method of claim 24 wherein said data is only transmitted to the server when a wireless connection is available to said mobile device and when the processor usage of the mobile device is below 30%.

30. The method of claim 24 wherein the routines comprise an events method and wherein said events method monitors for an occurrence of predefined events in said application, wherein said predefined events comprise at least one of an instance of a mobile device user touching a screen of the mobile device, an instance of the mobile device user tapping the screen of the mobile device, an instance of the mobile device user tilting the screen of the mobile device, an instance of the mobile device user moving the screen of the mobile device horizontally, an instance of the mobile device user moving the screen of the mobile device vertically, or an instance of the mobile device user inputting data into the mobile device.
